(19) United States
(12) Patent Application Publication
(10) Pub. No.: US 2008/0005653 A1
(43) Pub. Date: Jan. 3, 2008

(54) Method and apparatus for facilitating Java-based self-organizing media

(76) Inventors: Viswanathan Swaminathan, Fremont, CA (US); Gerard Fernando, Mountain View, CA (US)

Correspondence Address: SUN MICROSYSTEMS INC.;C/O PARK, VAUGHAN & FLEMING LLP, 2820 FIFTH STREET, DAVIS, CA, 95618-7759, US

(21) Appl. No.: 11/479,891

(22) Filed: Jun. 30, 2006

(51) Int. Cl. G06F 17/00; G06F 15/00

(52) U.S. Cl. 715/500.1

(57) ABSTRACT

One embodiment of the present invention provides a system that facilitates presentation of Java-based self-organizing media. During operation, the system receives media content at a media-presentation device, wherein the media content includes content data as well as a Java-based descriptor describing characteristics of the media content. The system further issues a request based on the descriptor and characteristics of the media-presentation device for information to facilitate presentation of the media content independent of an underlying platform and media-player framework. In response to the request, the system receives the information which allows the media-presentation device to present the media content.

### BACKGROUND

1. Field of the Invention

The present invention relates to techniques for storing, transmitting, compressing, and presenting multimedia data. More specifically, the present invention relates to a method and an apparatus that facilitates presentation of Java-based self-organizing media which is independent of the platform and the media-presentation software.

2. Related Art

The ubiquity of Internet connectivity and abundance of access bandwidth have significantly changed the form and distribution of media content. Multimedia content, including graphics, text, sound, and video, is quickly replacing conventional single-media content. Furthermore, the ever-increasing computing power available today continues to fuel the demand for media-rich content.

The most common multimedia content distributed over the Internet remains video-rich. Different encoding formats and player frameworks are available for presenting video. For example, the Motion Picture Experts Group (MPEG) standards provide several encoding schemes, such as the MPEG-1, MPEG-2, and MPEG-4 standards. Additionally, different media-player frameworks, such as Microsoft's Windows Media Player family, Apple's QuickTime family, and RealNetworks' Real Player family, compete for market share. These media-presentation applications use different decoding schemes and protocols, and are specific to platforms such as Windows, MacOs, and Linux.

Although these media-presentation applications allow certain interactivity to be embedded in a video stream, the range of interactivity is limited, and the authoring of such content is framework-specific and thus time consuming. For example, if a content provider is to distribute a video clip with certain interactive features, he needs not only to encode the video in different formats, such as Windows Media and QuickTime, but also to author the interactive features for each format and platform separately. Moreover, the content providers are expected to provide clips for different speeds, for example, 28 Kbps, 56 Kbps, and 384 Kbps, for each format.

The MPEG-J standard (hereinafter “MPEG-J”) is a Java-based extension to the MPEG-4 standard that facilitates platform- and framework-independent interactivity and graceful degradation in video content. MPEG-J provides a mechanism for including Java classes within MPEG-4 content. An MPEG-J encoded video clip allows graceful degradation with limited or time-varying resources. Moreover, an MPEG-J encoded video clip responds to user interaction by providing programmatic control of the media-presentation application. Because Java is a platform-independent programming language, these features can be independent of the underlying operating system.

However, MPEG-J does not participate in the processing of content data, especially, data for real-time content. To target users of different media-presentation applications, a content provider needs to author multiple clips of the same content encoded in different formats, such as MPEG-2 and MPEG-4. Additionally, introducing new encoding or encrypting schemes is difficult, because a user is required to manually download a new decoder or decryptor specific to his media-presentation application. Therefore, organizing media assets with numerous formats, encoding schemes, and encrypting schemes remains a resource-demanding task.

Hence, what is needed is a method and an apparatus for facilitating self-organizing media that is platform- and framework-independent.

### SUMMARY

One embodiment of the present invention provides a system that facilitates presentation of Java-based self-organizing media. During operation, the system receives media content at a media-presentation device, wherein the media content includes content data as well as a Java-based descriptor describing characteristics of the media content. The system further issues a request based on the descriptor and characteristics of the media-presentation device for information to facilitate presentation of the media content independent of an underlying platform and media-player framework. In response to the request, the system receives the information which allows the media-presentation device to present the media content.

In a variation of this embodiment, the received information includes a Java object that enables the media-presentation device to process the content data.

In a further variation, the Java object includes a decoder module, a transcoder module, or a security module.

In a variation of this embodiment, receiving the media content involves receiving the content data in a first virtual channel and receiving the descriptor in a second virtual channel.

In a variation of this embodiment, the descriptor is obtained at the media-presentation device. The media-presentation device then sends the descriptor to an intermediate node, which acts as an agent for the media-presentation device. Additionally, issuance of the request occurs at the intermediate node.

In a variation of this embodiment, the system sends the request to a server which processes the request and provides the information necessary for the media-presentation device to present the media.

In a variation of this embodiment, issuing the request involves sending a lookup query for a service to a federation of services.

In a further variation, the federation of services is constructed based on a JINI network architecture.

In a further variation, the Java-based descriptor is a Java object or an XML descriptor.

A further embodiment of the present invention provides a system that facilitates presentation of Java-based self-organizing media. During operation, the system receives media content at a media-presentation device, wherein the media content embeds a Java-based media handling component. The system extracts this component from the received data wherein this component enables the media-presentation device to present the media content, and presents the media content using the extracted component.

In a variation of this embodiment, the Java-based media handling component is a decoder, transcoder, or a security module embedded as Java bytecode.

### BRIEF DESCRIPTION OF THE FIGURES

FIG. 1 illustrates the high-level functions and features provided by Java-based self-organizing media in accordance with one embodiment of the present invention.

FIG. 2 illustrates an exemplary configuration of a media-presentation application which plays Java-based self-organizing media in accordance with one embodiment of the present invention.

FIG. 3 illustrates an exemplary configuration of a mobile device which plays Java-based self-organizing media with the assistance of a base station in accordance with one embodiment of the present invention.

FIG. 4 presents a flow chart illustrating the process of playing Java-based self-organizing media without the assistance of an intermediate node in accordance with one embodiment of the present invention.

FIG. 5 presents a flow chart illustrating the process of playing Java-based self-organizing media with the assistance of an intermediate node in accordance with one embodiment of the present invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

The operation procedures described in this detailed description may be stored on a digital-circuit readable storage medium, which may be any device or medium that can store code and/or data for use by digital circuits. This includes, but is not limited to, application specific integrated circuits (ASICs), field-programmable gate arrays (FPGAs), semiconductor memories, and magnetic or optical storage devices such as disk drives, magnetic tape, CDs (compact discs) and DVDs (digital versatile discs or digital video discs).

### Java-Based Self-Organizing Multimedia Content

Embodiments of the present invention provide a mechanism that moves intelligence from the source (server) or destination (client) to the media content, so that the media content is self-descriptive. In particular, embodiments of the present invention allow a wide range of Java program components to be embedded with media content. A component can be a descriptor for the content and assist the media-presentation application to obtain additional information, such as a decoder or a transcoder, to play the media. In further embodiments, such a component can be a Java-based handler component, such as a plug-in, which, when used by the media-presentation application, can directly handle the media. Note that the term “handle” refers to a variety of operations performed on the content data, including decrypting, decoding, and transcoding (to change the encoding scheme from one format, such as MPEG-4, to another, such as MPEG-2). Other operations are possible. Additionally, the media content can embed sufficient self-descriptive information as Java-based components for handling the content data and hence become self-organizing.

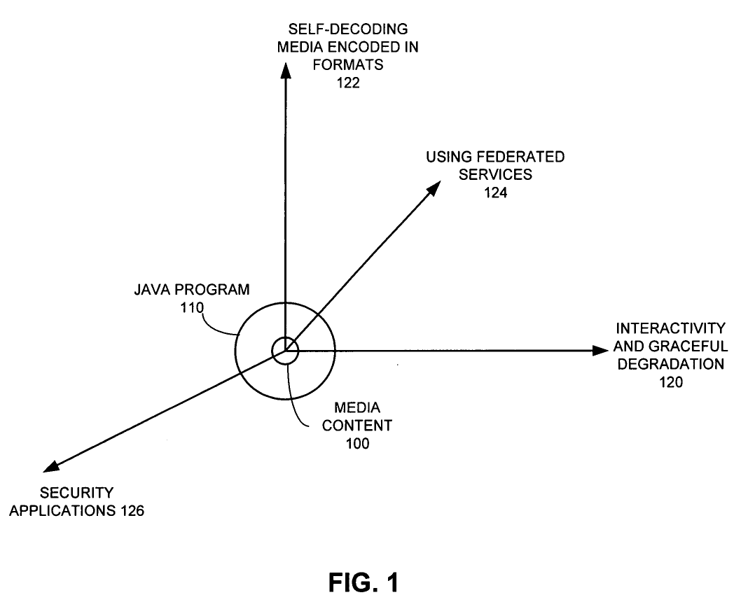

FIG. 1 illustrates the high-level functions and features provided by Java-based self-organizing media in accordance with one embodiment of the present invention. Media content 100, when delivered with embedded Java program 110, becomes self-organizing, and can provide functions and features in numerous logical dimensions. In one dimension, the media content can provide interactivity and graceful degradation features 120 through programmatic controls. Furthermore, self-organizing media content 100 allows the media-presentation application to access a set of federated services 124 based on the self-descriptive information for media content 100. In one embodiment, such federated services are provided through the JINI network architecture, where a host can access services provided by peer nodes within the JINI federation. For example, when searching a new codec to decode media content 100, the media-presentation application can post a request, based on the Java descriptor for the media content, to a JINI federation, and receives the requested codec from a member node.

Java program 110 can also include a media handler component. A content provider can hence deliver self-decoding media encoded in new formats 122 without updating the media-presentation application. Further embodiments of the present invention provide new security applications 126 together with media content 100. For instance, Java program 110 can include a security module which allows the media-presentation application to confirm that media content 100 is from a trusted source and free of malicious content. Other functions and features are possible with Java-based self-organizing media.

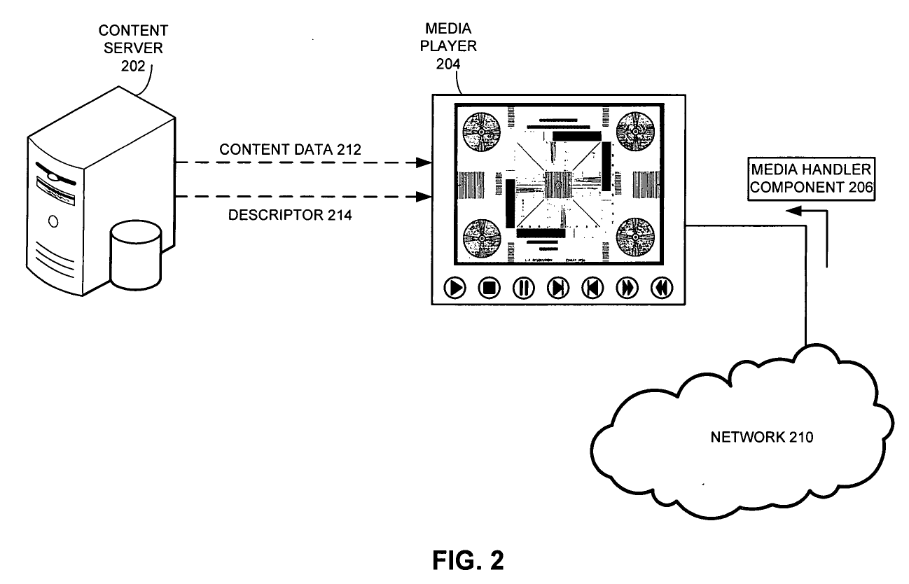

FIG. 2 illustrates an exemplary configuration of a media-presentation application which plays Java-based self-organizing media in accordance with one embodiment of the present invention. A content server 202 delivers both content data 212 and a descriptor 214 to a media player 204. Content server 202 delivers content data 212 and descriptor 214 over two separate logical, virtual channels. The underlying transport mechanism can take various forms. In one embodiment, content data 212 embeds descriptor 214 and the two virtual channels are encapsulated in a single data stream. In further embodiments, content data 212 and descriptor 214 can be downloaded or streamed separately. Concurrent delivery of content data 212 and descriptor 214 can be optional because, unlike MPEG-J where programmatic control for interactivity is synchronized to the media presentation, descriptor 214 does not need to be synchronized to content data 212.

In general, descriptor 214 can take numerous forms, such as a Java object or an Extensible Markup Language (XML) metadata based on MPEG-7. In a preferred embodiment, descriptor 214 is an executable Java bytecode. Hence, media player 204 can interpret descriptor 214 independent of the underlying platform. Descriptor 214 provides information necessary for handling content data 212, such as the encoding format and encryption scheme.

Media player 204 interprets descriptor 214 and determines whether presentation of content data 212 is possible with existing handler components. Such handler components can be plug-ins for a particular media-player framework within media player 204. If playing content data 212 is not possible with existing plug-ins, media player 204 can obtain the handler component over a network 210.

In one embodiment, media player 204 obtains the handler component from a server residing within network 210. Because the handler component is typically specific to the platform and the media-player framework, media player 204 constructs a request using information provided by descriptor 214 and the characteristic information of the underlying system. Media player 204 communicates this request to a server within network 210, which responds with a media handler component 206. Media player 204 subsequently loads handler component 206 and plays content data 212.

In a further embodiment, descriptor 214 includes a handler component. Media player 204 can load the handler component directly and play content data 212 without contacting a server over network 210.

Note that the descriptor can serve different purposes. For example, descriptor 212 can assist media player 204 to obtain a decoder or transcoder specific to a media-player framework, such as the Java Media Framework. In a further example, descriptor 212 provides sufficient information for media player 204 to obtain security tools from different providers based on a security framework, such as the Java Cryptography Extensions (JCE) framework.

In one exemplary application, an encrypted MP3 audio stream is delivered as Java-based self-organizing media. The MP3 audio stream can be encrypted with a Data Encryption Standard (DES) or a proprietary encryption scheme. The media player is a native MP3 player which can perform Java-based decryption using a JCE framework and can access a JINI federation of services. If the MP3 stream is encrypted with the DES scheme, the MP3 player can decrypt the stream with JCE directly. If the stream is encrypted with the proprietary scheme, and if the MP3 player is attempting to play the stream for the first time, the MP3 player can request the proprietary decryption service from the JINI federation using a lookup server. In response to the request, the MP3 player receives the Java components, which can be Java classes, from the discovered service. The MP3 player subsequently loads the classes in JCE, decrypts the stream, and plays the stream.

### Obtaining Handler Component Through Intermediate Node

Embodiments of the present invention allow media-presentation devices with limited resources to handle Java-based self-organizing media. For example, a mobile device may not have sufficient resource, such as computing power or memory, to process the descriptor when receiving a video stream in real time. In one embodiment, the media-presentation device forwards the received descriptor to an intermediate node. This intermediate node, while acting as an agent or proxy, obtains the necessary handler component to facilitate the media presentation.

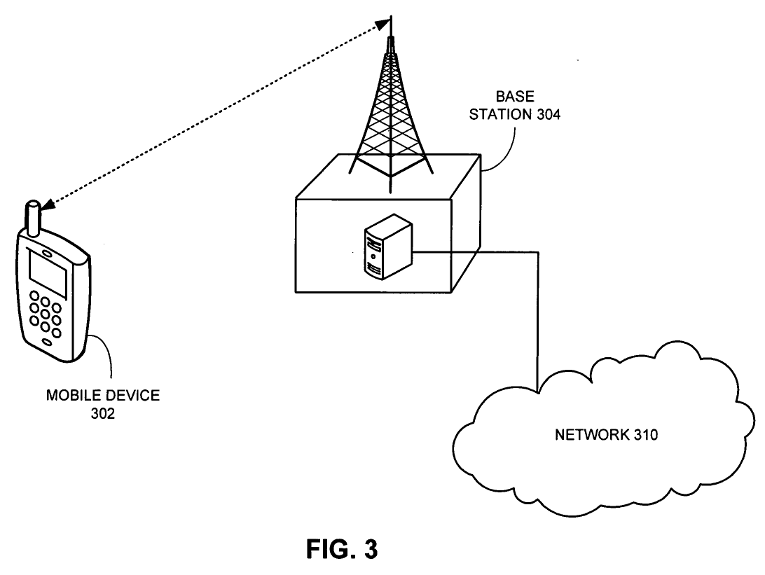

FIG. 3 illustrates an exemplary configuration of a mobile device which plays Java-based self-organizing media with the assistance of a base station in accordance with one embodiment of the present invention. A mobile device 302 receives Java-based self-organizing media content through a wireless signal. If incapable of handling the content, mobile device 302 forwards the content descriptor to a base station 304, which acts as an agent or proxy for mobile device 302. Base station 304 maintains a knowledge base that includes information about the platform and media-player framework of mobile device 302. Hence, base station 304 can obtain the necessary media handler component over a network 310. In one embodiment, base station 304 communicates with a server residing within network 310, which responds to base station 304's request with a handler component. In a further embodiment, base station 304 can obtain the handler component from one or more peer nodes which are members of a federation of services, such as a JINI federation.

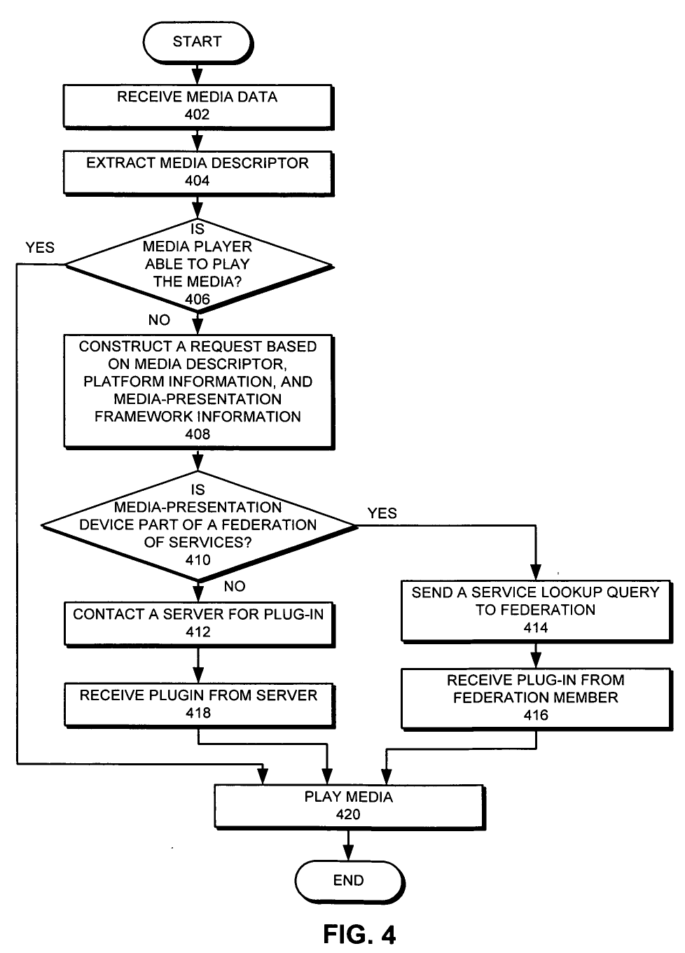

FIG. 4 presents a flow chart illustrating the process of playing Java-based self-organizing media without the assistance of an intermediate node in accordance with one embodiment of the present invention. The system starts by receiving media data (step 402) and extracting the Java-based media descriptor (step 404). The system subsequently determines whether the media player is able to play the received media content (step 406). If the system is able to do so, media player starts playing the media (step 420).

If the system cannot readily play the received media content, the system constructs a request based on the media descriptor, platform information, and media-player framework information (step 408). The request may be based on additional information about the media, the media player, or the underlying system. The system further determines whether the media-presentation device is part of a federation of services (step 410). If so, the system sends a service lookup query to the federation based on the constructed request (step 414). In response, the system receives a plug-in from a federation member (step 416), and starts playing the media (step 420)

If the media-presentation device is not part of the federation of services, the system contacts a server for the plug-in based on the request (step 412). After receiving the plug-in from the server (step 418), the system plays the media (step 420)

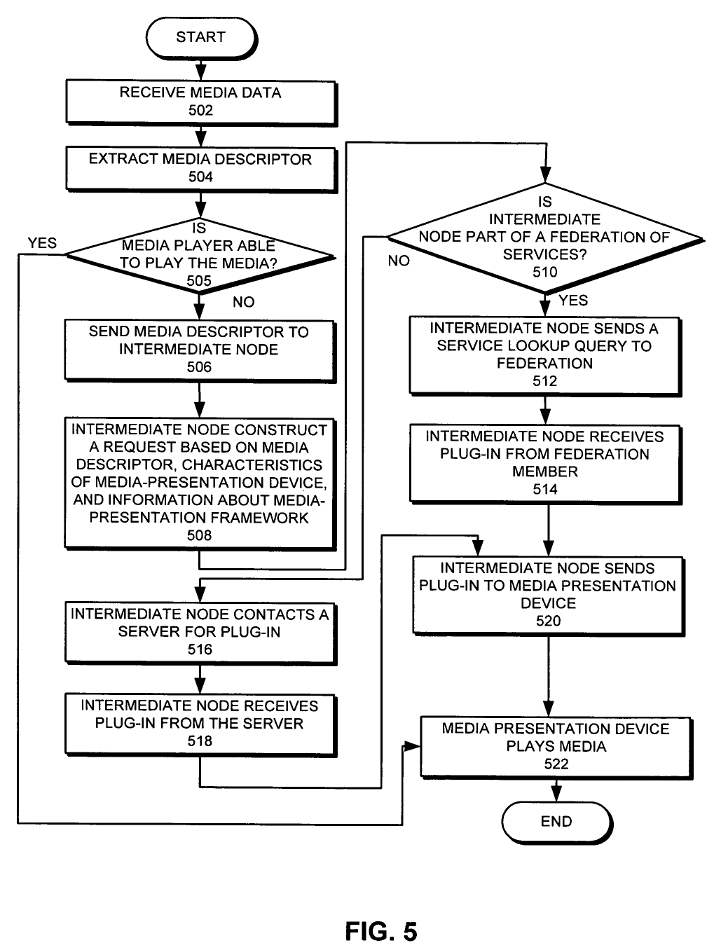

FIG. 5 presents a flow chart illustrating the process of playing Java-based self-organizing media with the assistance of an intermediate node in accordance with one embodiment of the present invention. The system starts by receiving media data (step 502) and extracting the Java-based media descriptor (step 504). The system subsequently determines whether the media player is able to play the media content (step 505). If so, the media-presentation device proceeds to play the media content (step 522).

If the system cannot readily play the received media content, the system sends the received media descriptor to an intermediate node (step 506). The intermediate node constructs a request based on the media descriptor, the characteristics of the media-presentation device, such as platform information, and information about the media-player framework (step 508). The intermediate node further determines whether itself is part of a federation of services (step 510). If so, the intermediate node sends a service lookup query to the federation based on the constructed request (step 512). In response, the intermediate node receives a plug-in from a federation member (step 514) and sends the received plug-in to the media-presentation device (step 520), which subsequently starts playing the media content (step 522).

If not part of the federation of services, the intermediate node contacts a server for the plug-in based on the request (step 516). In response, the intermediate node receives a plug-in from the server (step 518) and sends the received plug-in to the media-presentation device (step 520), which subsequently starts playing the media content (step 522).

In a further embodiment, the media presentation device can forward the received media content that is not readily playable to the intermediate node. In response, the intermediate node obtains a transcoder based on the media descriptor and transforms the media content into a format that can be played by the media presentation device. The transformed media content is subsequently delivered back to the presentation device for playback.

The foregoing descriptions of embodiments of the present invention have been presented for purposes of illustration and description only. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. A method for facilitating presentation of Java-based self-organizing media, the method comprising:
receiving media content at a media-presentation device, wherein the media content includes content data as well as a Java-based descriptor describing characteristics of the media content;
issuing a request based on the descriptor and characteristics of the media-presentation device for information to facilitate presentation of the media content independent of an underlying platform and media-player framework; and
in response to the request, receiving the information which allows the media-presentation device to present the media content.

2. The method of claim 1, wherein the received information includes a Java object that enables the media-presentation device to process the content data.

3. The method of claim 2, wherein the Java object includes a decoder module, a transcoder module, or a security module.

4. The method of claim 1, wherein receiving the media content involves receiving the content data in a first virtual channel and receiving the descriptor in a second virtual channel.

5. The method of claim 1,
wherein obtaining the descriptor involves obtaining the descriptor at the media-presentation device;
wherein the method further comprises sending the descriptor to an intermediate node which acts as an agent for the media-presentation device; and
wherein issuance of the request occurs at the intermediate node.

6. The method of claim 1, further comprising sending the request to a server which processes the request and provides the information necessary for the media-presentation device to present the media.

7. The method of claim 1, wherein issuing the request involves sending a lookup query for a service to a federation of services.

8. The method of claim 7, wherein the federation of services is constructed based on a JINI network architecture.

9. The method of claim 1, wherein the Java-based descriptor is a Java object or an XML descriptor.

10. A method for facilitating presentation of Java-based self-organizing media, the method comprising:
receiving media content at a media-presentation device, wherein the media content embeds a Java-based media handling component;
extracting the Java-based media handling component from the received data, wherein the Java-based media handling component enables the media-presentation device to process the content data; and
presenting the media content using the extracted media handling component.

11. The method of claim 10, wherein the Java-based media handling component can include a decoder, transcoder, or a security module embedded as Java bytecode.

12. A computer-readable storage medium storing instructions that when executed by a computer cause the computer to perform a method for facilitating presentation of Java-based self-organizing media, the method comprising:
receiving media content at a media-presentation device, wherein the media content includes content data as well as a Java-based descriptor describing characteristics of the media content;
issuing a request based on the descriptor and characteristics of the media-presentation device for information to facilitate presentation of the media content independent of an underlying platform and media-player framework; and
in response to the request, receiving the information which allows the media-presentation device to present the media content.

13. The computer-readable storage medium of claim 12, wherein the received information includes a Java object that enables the media-presentation device to process the content data.

14. The computer-readable storage medium of claim 13, wherein the Java object includes a decoder module, a transcoder module, or a security module.

15. The computer-readable storage medium of claim 12, wherein receiving the media content involves receiving the content data in a first virtual channel and receiving the descriptor in a second virtual channel.

16. The computer-readable storage medium of claim 12,
wherein obtaining the descriptor involves obtaining the descriptor at the media-presentation device;
wherein the method further comprises sending the descriptor to an intermediate node which acts as an agent for the media-presentation device; and
wherein issuance of the request occurs at the intermediate node.

17. The computer-readable storage medium of claim 12, wherein the method further comprises sending the request to a server which processes the request and provides the information necessary for the media-presentation device to present the media.

18. The computer-readable storage medium of claim 12, wherein issuing the request involves sending a lookup query for a service to a federation of services.

19. The computer-readable storage medium of claim 18, wherein the federation of services is constructed based on a JINI network architecture.

20. The computer-readable storage medium of claim 12, wherein the descriptor is a Java-based media handling component which enables the media-presentation device to play the media content.

21. The computer-readable storage medium of claim 20, wherein the Java-based media handling component includes a decoder, transcoder, or a security module embedded as Java bytecode.

22. The computer-readable storage medium of claim 12, wherein the Java-based descriptor is a Java object or an XML descriptor.

23. An apparatus for facilitating presentation of Java-based self-organizing media, the apparatus comprising:
a media-presentation device;
a receiving mechanism configured to receive media content at the media-presentation device, where in the media content includes content data as well as a Java-based descriptor describing characteristics of the media content;
a requesting mechanism configured to issue a request based on the descriptor and characteristics of the media-presentation device for information to facilitate presentation of the media content independent of an underlying platform and media-player framework; and
wherein in response to the request, the media-presentation device is configured to receive the information which allows the media-presentation device to present the media content.
